(19) United States
(12) Patent Application Publication
(10) Pub. No.: US 2023/0177500 A1
(43) Pub. Date: Jun. 8, 2023

(54) METHOD OF CONDUCTING FINANCIAL TRANSACTIONS

(71) Applicant: WHISTLE SYSTEMS, INC., Saint Louis, MO (US)

(72) Inventors: Andrew HRDLICKA, Saint Louis, MO (US); Daniel CONWELL, Saint Louis, MO (US); Ben VALENTI, Saint Louis, MO (US); Drew CARTER, Saint Louis, MO (US); Chris DORNFELD, Saint Louis, MO (US)

(21) Appl. No.: 17/990,277

(22) Filed: Nov. 18, 2022

Related U.S. Application Data
(60) Provisional application No. 63/286,750, filed on Dec. 7, 2021.

(51) Int. Cl. G06Q 20/38; G06Q 20/36

(52) U.S. Cl. CPC G06Q 20/3829; G06Q 20/3674; G06Q 20/3825

(57) ABSTRACT

A method of conducting financial transactions is a blockchain-based method of securely transferring funds. First and second blockchain wallets are stored on a blockchain network. At least the first blockchain wallet contains a private key of a cryptographic key pair. When a request is made to transfer funds between the first blockchain wallet and the second blockchain wallet, a digital signature is generated from the private key. The digital signature represents authorization by a payer associated with the first blockchain wallet to initiate the transfer of funds to the second blockchain wallet. The digital signature is verified using a public key of the cryptographic key pair. The public key is associated with the blockchain network. The funds are transferred between the first blockchain wallet and the second blockchain wallet upon verification of the digital signature.

### CROSS-REFERENCE TO RELATED APPLICATION

This application claims the benefit of U.S. Provisional Pat. Application No. 63/286,750, filed on Dec. 7, 2021.

### BACKGROUND

### 1. Field

The disclosure of the present patent application relates to electronic transactions, and particularly to a method of conducting secure transactions through the usage of a blockchain network.

### 2. Description of the Related Art

A “blockchain” is a publicly viewable, append-only, distributed ledger having wide applications in the financial services industry. Blockchain entries consist of blocks of information that can include transactions, transaction record components, transaction entities, and the like. The advantages of blockchain technology include decentralization, immutability, security, anonymity, and transparency. The application of blockchain technology to financial transactions is of great interest due to the inherent security of blockchain networks.

In general, a financial transaction is performed between two parties, with a transfer of funds taking place between the two parties. The funds may include electronic currency and/or fiat currency. In either case, any financial transaction includes a variety of different data associated with the financial transaction, such as account numbers, business identifier codes of associated financial institutions, payment amount, etc. With each additional type of data required, it becomes more difficult to not only store the data, but track the data transmitted between different services and parties. Thus, in conventional electronic financial transactions, not only is the process complex, but each new transfer and type of data introduces additional security risks. Additionally, since the transaction relies on transmitting a wide variety of data to multiple servers, networks, parties, etc., it is not only difficult to ensure that integrity of the data is maintained, but it is also extremely difficult to provide evidence of the data transfer at the individual steps of the transaction. It would be desirable to apply the security, transparency, and immutability inherent in blockchain networks to financial transactions. Thus, a method of conducting financial transactions solving the aforementioned problems is desired.

### SUMMARY

The present subject matter relates to a method of conducting financial transactions which is a blockchain-based method of securely transferring funds. First and second blockchain wallets are stored on a blockchain network. A first blockchain related to an available balance of the first blockchain wallet and a second blockchain related to an available balance of the second blockchain wallet may be established. Each of the first and second blockchains includes a plurality of balance blocks, with at least one of the plurality of balance blocks having stored therein data representative of a current balance and a wallet identifier associated with the respective one of the first and second blockchain wallets.

In an embodiment, at least the first blockchain wallet contains a private key of a cryptographic key pair. According to this embodiment, when a request is made to transfer funds between the first blockchain wallet and the second blockchain wallet, a digital signature is generated from the private key. The digital signature represents authorization by a payer associated with the first blockchain wallet to initiate the transfer of funds to the second blockchain wallet. The digital signature is verified using a public key of the cryptographic key pair. The public key is associated with the blockchain network.

The funds are transferred between the first blockchain wallet and the second blockchain wallet upon verification of the digital signature. Each of the first and second blockchains respectively associated with the first and second blockchain wallets may be updated upon transfer of the funds.

When the initial request to transfer the funds between the first blockchain wallet and the second blockchain wallet is received, receipt of the request may take place on a processing server, where a payment request is received by the processing server and the payment request includes at least a payer identifier associated with a payer associated with the first blockchain wallet, and further includes the transaction amount. The processing server may generate a funding transaction data value including at least the payer identifier, a receiver identifier associated with a recipient associated with the second blockchain wallet, and the transaction amount. The generated funding transaction data value may then be published to the first and second blockchains.

It should be understood that the present method may be applied to data transfers in general and is not limited to financial transactions. The blockchain may be used to store any other type of data in an immutable format. As a non-limiting example, a blockchain may be used to track ownership of land deeds, where changes in ownership may be recorded as direct transfers (e.g., similar to transfers of currency) or where changes may be stored as data. In a further non-limiting example, a blockchain may be used for voting, where votes may be attributed to blockchain wallets and counted accordingly. Thus, each “transaction” discussed above may alternatively refer to the storage of any data in a blockchain, rather than being limited to financial transactions alone. In the above non-limiting example, a change in ownership in land deed or a vote in an election may be a transaction stored in the blockchain.

These and other features of the present subject matter will become readily apparent upon further review of the following specification.

### BRIEF DESCRIPTION OF THE DRAWINGS

FIG. 1 is a block diagram illustrating a network architecture for implementing the method of conducting financial transactions.

FIG. 2 is block diagram illustrating components and modules of a processing server used in the implementation of the method of conducting financial transactions.

Similar reference characters denote corresponding features consistently throughout the attached drawings.

### DETAILED DESCRIPTION OF THE PREFERRED EMBODIMENTS

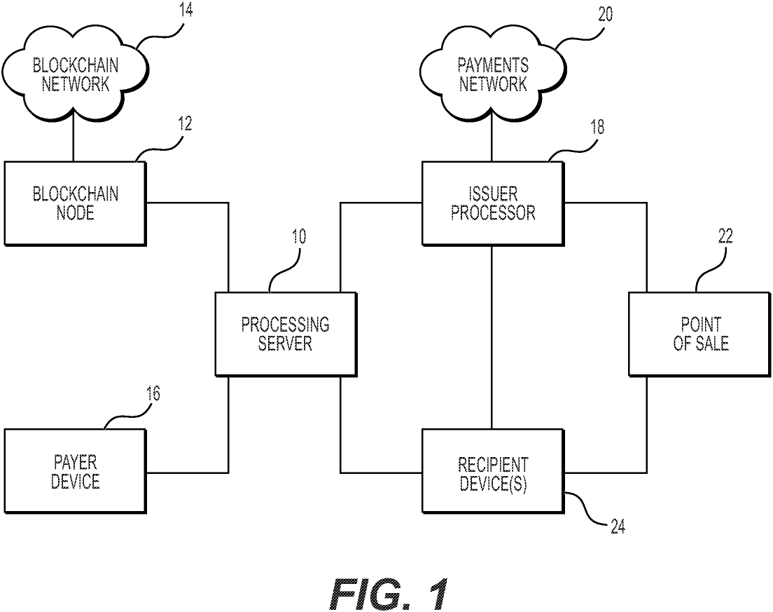

The method of conducting financial transactions is a blockchain-based method of securely transferring funds. As illustrated in FIG. 1, first and second blockchain wallets are stored on a blockchain network 14. In the non-limiting example of FIG. 1, the first blockchain wallet is associated with a payer and the second blockchain wallet is associated with a recipient. The payer utilizes payer device 16 to access the processing server 10 and initiate payment transactions. It should be understood that the payer device 16 may be any suitable type of device that is configured to communicate with processing server 10 and initiate transactions. Non-limiting examples of payer device 16 include smartphones, smart watches, tablet computers, notebook computers, laptop computers, desktop computers, and the like.

A first blockchain related to an available balance of the first blockchain wallet and a second blockchain related to an available balance of the second blockchain wallet may be established. Each of the first and second blockchains includes a plurality of balance blocks, with at least one of the plurality of balance blocks having stored therein data representative of a current balance and a wallet identifier associated with the respective one of the first and second blockchain wallets.

In order to establish the first and second blockchain wallets and the corresponding first and second blockchains, processing server 10 is in communication with a blockchain network 14. Although only a single blockchain node 12 is shown in FIG. 1 for purposes of simplification, it should be understood that blockchain network 14 typically includes a plurality of blockchain nodes 12. Each blockchain node 12 is configured to perform functions related to the processing and management of the blockchain, such as, by way of non-limiting example, the generation of blockchain data values, verification of proposed blockchain transactions, verification of digital signatures, generation of new blocks, validation of new blocks, and maintenance of a copy of the blockchain.

Each blockchain may be a distributed ledger formed from a plurality of blocks. Each block may include at least a block header and one or more data values. Each block header may include at least a timestamp, a block reference value, and a data reference value. The timestamp may be a time at which the block header was generated and may be represented using any suitable method. The block reference value may be a value that references an earlier block (e.g., based on the timestamp) in the blockchain. As a non-limiting example, a block reference value in a block header may be a reference to the block header of the most recently added block prior to the current block. As a further non-limiting example, the block reference value may be a hash value generated via the hashing of the block header of the most recently added block. The data reference value may similarly be a reference to the one or more data values stored in the block that includes the block header. In a further non-limiting example, the data reference value may be a hash value generated via the hashing of the one or more data values. As another non-limiting example, the block reference value may be the root of a Merkle tree generated using the one or more data values.

The use of the block reference value and data reference value in each block header may result in the blockchain being immutable. Any attempted modification to a data value would require the generation of a new data reference value for that block, which would thereby require the subsequent block’s block reference value to be newly generated, further requiring the generation of a new block reference value in every subsequent block. This would have to be performed and updated in every single node in the blockchain network prior to the generation and addition of a new block to the blockchain for the change to be made permanent. Computational and communication limitations may make such a modification exceedingly difficult, if not impossible, thus rendering the blockchain immutable.

At least the first blockchain wallet contains a private key of a cryptographic key pair. When a request is made to transfer funds between the first blockchain wallet and the second blockchain wallet, a digital signature is generated from the private key. The digital signature represents authorization by a payer associated with the first blockchain wallet to initiate the transfer of funds to the second blockchain wallet. The digital signature is verified by the blockchain network 14 using a public key of the cryptographic key pair. The public key is associated with the blockchain network 14.

It should be understood that each blockchain wallet may contain just the private key itself or, alternatively, each blockchain wallet may be a module of the processing server 10 that stores the private key for use thereof in blockchain transactions. As a non-limiting example, each payer and recipient may have been assigned their own private key for respective cryptographic key pairs, and these may each be contained in a blockchain wallet for use in transactions with the blockchain associated with the blockchain network 14.

The funds are transferred between the first blockchain wallet and the second blockchain wallet upon verification of the digital signature. Each of the first and second blockchains respectively associated with the first and second blockchain wallets may be updated upon transfer of the funds.

When the initial request to transfer the funds between the first blockchain wallet and the second blockchain wallet is received, receipt of the request may take place on a processing server 10, where a payment request is received by the processing server 10 and the payment request includes at least a payer identifier associated with a payer associated with the first blockchain wallet, and further includes the transaction amount. The processing server 10 may generate a funding transaction data value including at least the payer identifier, a receiver identifier associated with a recipient associated with the second blockchain wallet, and the transaction amount. The generated funding transaction data value may then be published to the first and second blockchains.

The processing server 10 may further process a funding transaction request from the payer. As a non-limiting example, the payer may make a credit card payment via a payment transaction processor. In this non-limiting example, the processing server 10 receives the payment, assigns the payer a master budget wallet on the blockchain network 14, and transfers corresponding blockchain tokens into the newly created wallet. When the payer wants to make payments to recipients, after a master budget wallet has been created and funded, the payer may access the processing server 10 to create payment program wallets by establishing a budget amount and payment rules for the program. The processing server 10 updates the balance blockchain by generating a transaction data value including at least the funding wallet identifier, the receiving wallet identifier, and the transaction amount, with the funding wallet identifier being based on at least the payer identifier, and the receiving wallet identifier being based on at least the payer and program identifiers.

In the above example which includes the establishment of rules, the processing server 10 may track payer input and program rules to determine when to make payments to the recipients. At the time of payment, the processing server 10 first checks if a new blockchain wallet should be created for the recipient. The recipient must have at least one blockchain wallet established but could have many wallets depending on how many program rules must be tracked for the recipient. As a non-limiting example, a recipient could have one wallet to track unconditional payments received from the payer, and a second wallet to track conditional payments that the payer could recover from the recipient based on the rules of the payment program.

As discussed above, the processing server 10 updates the balance blockchain by generating a transaction data value including at least the funding wallet identifier, the receiving wallet identifier, and the transaction amount, with the funding wallet identifier being based on at least the payer and program identifiers, and the receiving wallet identifier being based on at least the payer, recipient, and program identifiers. After updating the recipient wallet balances, the processing server may then transmit instructions to an issuer processor 18 to load funds to a prepaid transaction card account in the name of the recipient. The issuer processor 18 connects directly with a payments network 20 and an issuing bank to provide the system of record, manage issuance of cards, authorize transactions, and communicate with settlement entities.

The recipient may use a recipient device 24 to access the issuer processor 18 through the processing server 10 to facilitate the issuance of a prepaid payment card. It should be understood that the recipient device 24 may be any suitable type of device that is configured to communicate with issuer processor 18 through the processing server 10. Non-limiting examples of recipient device 16 include smartphones, smart watches, tablet computers, notebook computers, laptop computers, desktop computers and the like. As a non-limiting example, the recipient can use one or more recipient devices 24 to access a virtual card displayed by the issuer processor 18, request a physical payment card from the issuer processor 18, or tokenize a virtual or physical payment card into a mobile wallet.

As a further non-limiting example, the recipient may spend funds from the payer by presenting a payment card issued by the issuer processor 18 at a point of sale 22 in exchange for goods and services from a merchant. The payments network 20 approves or declines the transaction at the point of sale 22 based on the result of a transaction authorization provided by the issuer processor 18. Settlement of each transaction is facilitated by the issuing bank associated with the issuer processor 18.

The issuer processor 18 may provide details of each point of sale transaction to the processing server 10. These transaction details may include details such as the transaction date and time, the amount, the merchant name, and the merchant category code, for example. The processing server 10 updates the balance blockchain by generating a transaction data value including at least the funding wallet identifier, the receiving wallet identifier, and the transaction amount, with the funding wallet identifier being based on at least the recipient and transaction details compared to payment program rules, and the receiving wallet identifier being the used funds wallet associated with the processing server 10.

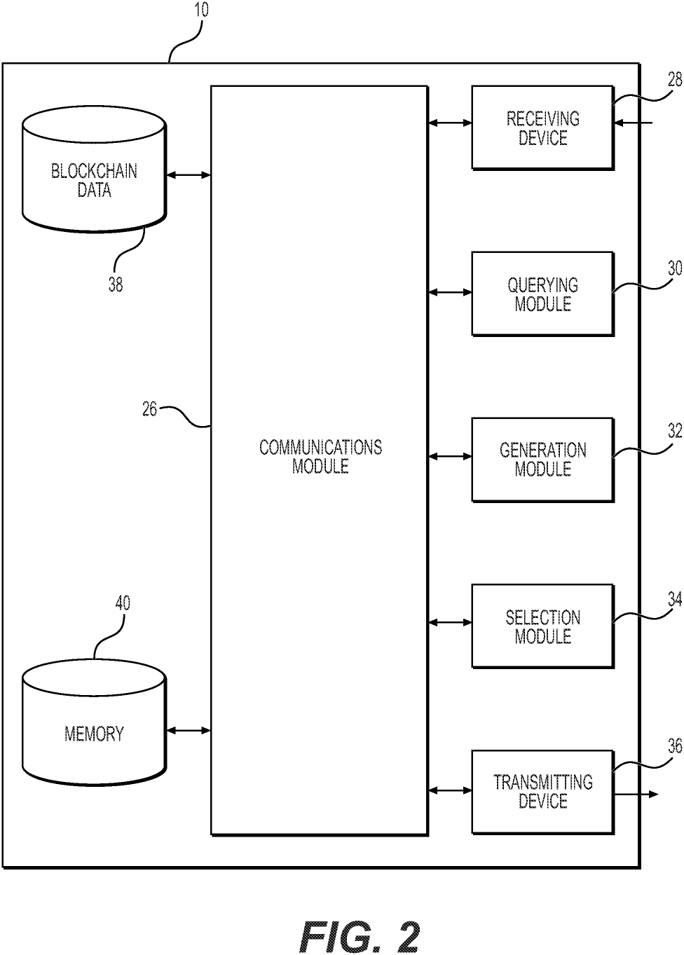

It should be understood that the processing server 10 may be any suitable type of server configured to implement the method described above. As shown in FIG. 2, the processing server 10 may include a receiving device 28 configured to receive data over one or more networks via one or more network protocols. The receiving device 28 may be configured to receive data from payer device 16, blockchain nodes 12, issuer processor 18, recipient device(s) 24, and other connected systems or entities via one or more communication methods, such as radio frequency, local area networks, wireless area networks, cellular communication networks, Bluetooth, the internet and the like, for example. It should be understood that multiple receiving devices may be employed, such as, for example, a first receiving device for receiving data over a local area network and a second receiving device for receiving data via the internet. The receiving device 28 may receive electronically transmitted data signals, where data may be superimposed or otherwise encoded on the data signal and decoded, parsed, read, or otherwise obtained via receipt of the data signal by the receiving device 28. Additionally, the receiving device 28 may include a parsing module for parsing the received data signal to obtain the data superimposed thereon. For example, the receiving device 28 may include a parser program configured to receive and transform the received data signal into usable input for the functions performed by the processing device to carry out the above-described method.

The receiving device 28 may be configured to receive data signals electronically transmitted by payer device 16 that are superimposed or otherwise encoded with payment requests for payments to be made by the payer. Each payment request may include at least a digital signature, payment amount, and an account identifier for the recipient of the payment. The receiving device 28 may also be configured to receive data signals electronically transmitted by blockchain nodes 12, which may be superimposed or otherwise encoded with new blocks or blockchain data values, confirmations for submitted blocks, public keys, etc. The receiving device 28 may be further configured to receive data signals electronically transmitted by issuer processor 18 that may be superimposed or otherwise encoded with point of sale transaction details associated with recipients using their payments cards issued by the issuer processor 18. The receiving device 28 may be configured to receive data signals electronically transmitted by recipient device 24 that may be superimposed or otherwise encoded with data to pass through to the issuer processor 18.

The processing server 10 may also include a communication module 26. The communication module 26 may be configured to transmit data between modules, engines, databases, memories, and other components of the processing server 10. It should be understood that any suitable type of communication module may be used. As a non-limiting example, the communication module 26 may include a bus, contact pin connectors, wires, etc. The communication module 26 may also be configured to communicate between internal components of the processing server 10 and external components of the processing server 10, such as externally connected databases, display devices, input devices, etc. The processing server 10 may also include a processing device. The processing device may be configured to perform the functions of the processing server 10, and may include a plurality of engines and/or modules specially configured to perform one or more functions of the processing device, such as a querying module 30, generation module 32, selection module 34, etc. As used herein, the term “module” may be software or hardware particularly programmed to receive an input, perform one or more processes using the input, and provide an output.

The processing server 10 may also include a memory 40. The memory 40 may be configured to store data for use by the processing server 10, such as public and private keys, symmetric keys, etc. The memory 40 may be configured to store data using any suitable data formatting methods and schema and may be any suitable type of memory, such as read-only memory, random access memory, etc. The memory 40 may include, for example, encryption keys and algorithms, communication protocols and standards, data formatting standards and protocols, program code for modules and application programs of the processing device, and other data that may be suitable for use by the processing server 10. As a non-limiting example, the memory 40 may include a database that utilizes structured query language for the storage, identification, modifying, updating, accessing, etc. of structured data sets stored therein. The memory 40 may be configured to store, for example, cryptographic keys, salts, nonces, communication information for the back-end system, etc.

The memory 40 may be further configured to store algorithms for use in generating blocks for the blockchains and validating digital signatures, algorithms for the creation of payment programs by a payer, algorithms for the processing of transactions from the issuer processor 18, and other data for use in performing the method described above. The processing server 10 may also be configured to store blockchain wallet data 38, which may be included in the memory 40 or stored separately in the processing server 10 or in an external storage accessible by the processing server 10. The blockchain wallet data 38 may include at least the cryptographic private keys associated with payer and recipient wallets, as discussed above.

As noted above, the processing server 10 may include a querying module 30. The querying module 30 may be configured to execute queries on databases to identify information. The querying module 30 may receive one or more data values or query strings and may execute a query string based thereon on an indicated database, such as the memory 40 of the processing server 10, to identify information stored therein. The querying module 30 may then output the identified information to an appropriate engine or module of the processing server 10, as necessary. The querying module 30 may, for example, execute a query on the blockchain wallet data 38 of the processing server 10 to identify blockchain data values for use in generating new blockchain data values, such as for updating balances.

The processing server 10 may also include a generation module 32. The generation module 32 may be configured to generate data for use by the processing server 10 in performing the method described above. The generation module 32 may receive instructions as input, may generate data based on the instructions, and may output the generated data to one or more modules of the processing server 10. For example, the generation module 32 may be configured to generate headers and blockchain data values that are included in new blocks generated for the balance blockchain. The generation module 32 may also be configured to generate notifications for transmission to issuer processor 18 regarding the transfer of funds to the prepaid card account of a recipient. The generation module 32 may also be configured to generate notifications for transmission to payer device 16 and recipient devices 24 regarding the status of payment transactions.

The processing server 10 may also include a selection module 34. The selection module 34 may be configured to perform selections for the processing server 10. The selection module 34 may receive instructions as input, may perform a selection as requested, and may output a result of the selection to another module or engine of the processing server 10. The selection module 34 may, for example, be configured to select impacted recipient 106 blockchain wallets based on prepaid card transactions at the point of sale 22. Selections may be based on any suitable criteria, such as payment program rules, transaction date and time, payer preferences, recipient preferences, etc.

The processing server 10 may also include a transmitting device 36. The transmitting device 36 is configured to transmit data over one or more networks via one or more network protocols. The transmitting device 36 may be configured to transmit data to payer device 16, blockchain nodes 12, issuer processor 18, recipient device(s) 24, and other systems and entities via one or more communication methods, such as, for example, local area networks, wireless area networks, cellular communication, Bluetooth, radio frequency, the Internet, etc. It should be understood that multiple transmitting devices may be used, such as, for example, a first transmitting device for transmitting data over a local area network and a second transmitting device for transmitting data via the internet. The transmitting device 36 may electronically transmit data signals that have data superimposed that may be parsed by a receiving computing device. The transmitting device 36 may further include one or more modules for superimposing, encoding, or otherwise formatting data into data signals suitable for transmission.

The transmitting device 36 may be configured to electronically transmit data signals to payer device 16 and recipient device(s) 24, which may be superimposed or otherwise encoded with payment status notifications and other data. The transmitting device 36 may also be configured to electronically transmit data signals to blockchain nodes 12, which may be superimposed or otherwise encoded with new blockchain data values, new blocks for confirmation, or confirmations of received blocks. The transmitting device 36 may be configured to electronically transmit data signals to issuer processor 18 that are superimposed or otherwise encoded with notifications regarding the transfer of funds to the prepaid card account of a recipient.

With regard to the method described above, as an example of a financial transaction, a blockchain related to available balances may be stored in memory 40 of processing server 10 in the form of blockchain data 38. As discussed above, the blockchain is formed from a plurality of balance blocks, where at least one of the plurality of balance blocks includes a specific balance data value including a current balance and a wallet identifier.

A payment funding request is received by receiving device 28 of the processing server 10, where the payment credit request including at least the payer identifier and a credit amount. A funding transaction data value is then generated by the generation module 32 of the processing server 10, where the funding transaction data value includes at least the funding wallet identifier, the receiving wallet identifier, and the transaction amount, with the funding wallet identifier being the issuing wallet associated with the processing server 10 and the receiving wallet identifier being based on at least the payer identifier. The generated funding transaction data value may be published by the processing server 10, via the transmitting device 36, to the blockchain related to available balances.

A payment program funding request may then be received by the receiving device 28 of the processing server 10, where the payment program funding request includes at least the payer identifier, the program identifier, a funding amount, and any payment rules associated with the program. A payment program transaction data value may then be generated by the generation module 32 of the processing server 10, where the payment program transaction data value includes at least the funding wallet identifier, the receiving wallet identifier, and the transaction amount, with the funding wallet identifier being based on at least the payer identifier and the receiving wallet identifier being based on at least the payer and program identifiers.

The generated payment program transaction data value may then be published by the processing server 10, via the transmitting device 36, to the blockchain related to available balances. A payment to a recipient may be calculated by the selection module 34 of the processing server 10, based on the payment rules of payment programs. A payment transaction data value may then be generated by the generation module 32 of the processing server, where the payment transaction data value includes at least the funding wallet identifier, the receiving wallet identifier, and the transaction amount, with the funding wallet identifier being based on at least the payer and program identifiers and the receiving wallet identifier being based on at least the payer, program, and receiver identifiers.

The generated payment transaction data value may be published by the processing server 10, via the transmitting device 36, to the blockchain related to available balances. The calculated payment to a receiver may be published by the processing server 10, via the transmitting device 36, to the issuer processor 18 to credit the prepaid account associated with the recipient of the payment.

A point of sale transaction message from the issuer processor 18 may be received by the receiving device 28 of the processing server 10, where the point of sale transaction message includes at least the receiver identifier, transaction date and time, transaction amount, merchant identifier, and merchant classifier code. A point of sale transaction data value may then be generated by the generation module 32 of the processing server 10, where the point of sale transaction data value includes at least the funding wallet identifier, the receiving wallet identifier, and the transaction amount, with the funding wallet identifier being based on at least the receiver and transaction details compared against payment program rules and the receiving wallet identifier being the used funds wallet associated with the processing server. The generated point of sale transaction data value may be published by the processing server 10, via the transmitting device 36, to the blockchain related to available balances.

It should be understood that the present method may be applied to data transfers in general and is not limited to financial transactions. The blockchain may be used to store any other type of data in an immutable format. As a non-limiting example, a blockchain may be used to track ownership of land deeds, where changes in ownership may be recorded as direct transfers (e.g., similar to transfers of currency) or where changes may be stored as data. In a further non-limiting example, a blockchain may be used for voting, where votes may be attributed to blockchain wallets and counted accordingly. Thus, each “transaction” discussed above may alternatively refer to the storage of any data in a blockchain, rather than being limited to financial transactions alone. In the above non-limiting example, a change in ownership in land deed or a vote in an election may be a transaction stored in the blockchain.

In the system 100, the blockchain network 14 maintains a balance blockchain. The balance blockchain may include blockchain data values that store a current balance for a payer’s 104 or recipient’s 106 blockchain wallet. The balance blockchain may be updated as payment transactions occur. In such cases a new block may be added for each transaction that includes a blockchain data value for each payer 104 or recipient 106 where the blockchain data value includes an identifier (e.g., the public key of the blockchain wallet’s cryptographic key pair) and an updated balance for the blockchain wallet.

It is to be understood that the method of conducting financial transactions is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

I claim:

1. A method of conducting financial transactions, comprising the steps of:
requesting a transfer of funds between a first blockchain wallet and a second blockchain wallet, wherein at least the first blockchain wallet contains a private key of a cryptographic key pair;
generating a digital signature from the private key, the digital signature representing authorization by a payer associated with the first blockchain wallet to initiate the transfer of funds;
verifying the digital signature using a public key of the cryptographic key pair, the public key being associated with a blockchain network, the first blockchain wallet and the second blockchain wallet each being on the blockchain network; and
transferring the funds between the first blockchain wallet and the second blockchain wallet upon verification of the digital signature.

2. The method of conducting financial transactions as recited in claim 1, further comprising the step of establishing a first blockchain related to an available balance of the first blockchain wallet.

3. The method of conducting financial transactions as recited in claim 2, further comprising the step of establishing a second blockchain related to an available balance of the second blockchain wallet.

4. The method of conducting financial transactions as recited in claim 3, further comprising the step of updating each of the first and second blockchains upon transfer of the funds between the first blockchain wallet and the second blockchain wallet.

5. The method of conducting financial transactions as recited in claim 4, wherein each of the first and second blockchains comprises a plurality of balance blocks, wherein at least one of the plurality of balance blocks has stored therein data representative of a current balance and a wallet identifier associated with the respective one of the first and second blockchain wallets.

6. The method of conducting financial transactions as recited in claim 5, wherein the step of requesting the transfer of funds between the first blockchain wallet and the second blockchain wallet comprises receipt of a payment request by a processing server, the payment request including at least a payer identifier associated with a payer associated with the first blockchain wallet and a transaction amount.

7. The method of conducting financial transactions as recited in claim 6, further comprising the step of generating a funding transaction data value comprising at least the payer identifier, a receiver identifier associated with a recipient associated with the second blockchain wallet, and the transaction amount.

8. The method of conducting financial transactions as recited in claim 7, further comprising publishing the funding transaction data value to the first and second blockchains.

9. A method of transferring data, comprising the steps of:
requesting a transmission of data between a first blockchain wallet and a second blockchain wallet, wherein at least the first blockchain wallet contains a private key of a cryptographic key pair;
generating a digital signature from the private key, the digital signature representing authorization by a sender associated with the first blockchain wallet to initiate the transmission of data;
verifying the digital signature using a public key of the cryptographic key pair, the public key being associated with a blockchain network, the first blockchain wallet and the second blockchain wallet each being on the blockchain network; and
transmitting the data between the first blockchain wallet and the second blockchain wallet upon verification of the digital signature.
